(19) United States
(12) Patent Application Publication
(10) Pub. No.: US 2005/0104562 A1
(43) Pub. Date: May 19, 2005

(54) Device for regulating the voltage in generators by means of coil tapping and a control relay

(76) Inventors: Ernst Hatz, Ruhstorf/Rott (DE); Franz Moser, Schardenberg (AT)

Correspondence Address: KATTEN MUCHIN ZAVIS ROSENMAN, 575 MADISON AVENUE, NEW YORK, NY, 10022-2585, US

(21) Appl. No.: 11/021,668

(22) Filed: Dec. 21, 2004

Related U.S. Application Data
(63) Continuation of application No. PCT/EP03/06220, filed on Jun. 13, 2003.

(30) Foreign Application Priority Data
Jun. 25, 2002 (DE) 102 28 226.9

(51) Int. Cl. H02P 9/00; H02H 7/06; H02P 11/00; G05F 1/10; G05F 3/02

(52) U.S. Cl. 322/28

(57) ABSTRACT

The invention relates to a device for automatically regulating the voltage of a generator according to the load current. Said device comprises a first couple of clamps which can be connected to a couple of generator clamps carrying the load current and taps a first generator voltage from the generator coil, a second couple of clamps which can be connected to the couple of generator clamps and picks up a second generator voltage that is smaller than the first generator voltage from the generator coil, a third couple of clamps that supplies a control voltage to a control circuit which is provided with a control relay (9) having a switch for switching the connection between the couple of generator clamps and the first couple of clamps or the second couple of clamps. The couple of generator clamps, which is connected to the first couple of clamps by means of the switch, is connected to the second couple of clamps if the control voltage is greater than or equal to an upper threshold voltage of the control relay while the couple of generator clamps, which is connected to the second couple of clamps by means of the switch, is connected to the first couple of clamps if the control voltage is less than or equal to a lower threshold voltage of the control relay. The inventive device also comprises a bridging element that bridges the connection established by the switch between the couple of generator clamps and the first couple of clamps and is provided with a varistor, the on-state voltage of which lies above the difference between the two generator voltages but below the first generator voltage.

### CROSS-REFERENCE TO RELATED APPLICATION

This application is a continuation of International Application No. PCT/EP2003/006220, which was filed on Jun. 13, 2003 and claims priority from German Patent Application 102 28 226.9 filed on Jun. 25, 2002, all of which are herein wholly incorporated by reference.

The present invention concerns a device for automatic regulating of the voltage of an electrical current producer (“generator”) depending on the load current. In particular, it concerns the use of such a device to regulate the voltage of a generator power by reciprocating internal combustion engine.

Devices for regulating the voltage of generators are known. In electrical current producers with electromagnets for exciting the induction coils, the generator voltage can be adapted to different load conditions, for example, by a variation of the control current for the electromagnets and a concomitant variation of the magnetic flux through the induction coils. However, such a simple voltage regulation is not possible in permanently excited generators. For the voltage regulation here, technically expensive regulation engineering measures are necessary, which is possible, for example, in the form of slip contacts along the primary coils for adjusting the number of active coil turns. The drawback in this case is that the slip contacts are highly prone to wear, caused in particular by abrasion and spark discharge. Furthermore, the often unavoidable short circuits between coil turns result in a not insignificant power loss. Another drawback is that brief current interruptions can always occur during the switching process.

DE 26 59 600 A1 describes a device for self-activated regulating of an electrical current producer depending on the load current, in which the regulation of the generator output voltage is done by short circuiting a partial coil of one phase with a triac, which is hooked up to a winding tap point and the neutral point.

US 2001/002802 A1 describes a motor whose rpm/torque characteristic is altered by switching the power supply voltage at winding tap points of the stator phase coils.

DE 100 47 287 A1 describes a device and a method for producing different output voltages with an alternating current generator, its being possible to change the configuration of the connections of the stator windings by means of a configuration circuit in order to produce different output voltages.

On the other hand, the problem of the present invention is to avoid expensive regulation engineering measures in order to adapt the generator voltage to different load conditions. Furthermore, current interruptions should no longer occur during the switching processes.

This problem is solved according to one proposal of the invention by the features of the independent claim. Advantageous configurations of the invention are given by the features of the dependent claims.

According to the invention, a device is indicated for the self-activated regulating of the voltage of an electrical current producer depending on the load current, in which a first and a second pair of clamps are provided for picking off a first and a second generator voltage from the generator winding. Both the first and the second pair of clamps can be connected to a pair of generator clamps, across which the load current is supposed to be conducted. Between the first pair of clamps there are always more winding turns than between the second pair of clamps, so that the voltage picked off at the first pair of clamps is always larger than the voltage picked off at the second pair of clamps. Both first and second pair of clamps can be fastened to any given point of the generator winding, as long as it is ensured that there are more turns between the first pair of clamps than between the second pair of clamps. The first generator voltage is preferably the main generator voltage, i.e., the voltage picked off from the complete winding of the generator. The second generator voltage is always a tap voltage, which is smaller than the main generator voltage.

Moreover, the device of the invention has a third pair of clamps, by which the control voltage for a control circuit can be picked off. The control voltage preferably corresponds to the voltage difference between the first generator voltage and the second generator voltage. The control circuit is preferably configured such that current flows only after reaching a particular on-state voltage. This can be accomplished, for example, by a Zener diode, whose avalanche voltage corresponds to the on-state voltage of the control circuit.

The control circuit has a control relay with a switch for alternately connecting the pair of generator clamps to the first or second pair of clamps, fastened to the generator winding. By moving the switch of the control relay, the pair of generator clamps connected by the switch to the first pair of clamps is connected to the second pair of clamps if the control voltage picked off at the third pair of clamps takes on a value greater than or equal to an upper threshold voltage of the switch relay. If the control circuit only becomes conducting after reaching an on-state voltage, the upper threshold voltage results as the sum of the on-state voltage of the control circuit, for example, the avalanche voltage of a Zener diode situated there, and the pulling voltage of the switch relay. On the contrary, the generator clamp connected by the switch to the second pair of clamps is connected by moving the switch to the first pair of clamps if the control voltage is smaller than or equal to a lower threshold voltage of the switch relay. The lower threshold voltage results as the sum of the on-state voltage of the control circuit, for example, the avalanche voltage of the Zener diode, and the release voltage of the switch relay.

The release voltage of the switch relay is always smaller than the pulling voltage of the switch relay, for which the switching hysteresis of the switch relay is responsible. The switching hysteresis is necessary for a stable switching of the relay, since an identical upper and lower threshold voltage, i.e., an equal switching voltage for the pulling and releasing, would produce an unstable switching condition, with a continual switching back and forth.

The interval between the upper and lower threshold voltage, i.e., the width of the switching hysteresis, generally depends on the dimensioning of the switch relay. The relative position of the switch hysteresis can be varied by the dimensioning of a Zener diode arranged in the circuit. A smaller avalanche voltage of the Zener diode will result in a shifting of the switch hysteresis toward smaller control voltages, and vice versa. Moreover, the Zener diode helps level out the potentials of the switch hysteresis.

If additional elements are present in the control circuit, such as a rectifying diode, which makes it possible to use with advantage a d.c. control relay, one can also take into account the on-state voltages of these elements for the magnitude of the control voltage needed to switch the control relay.

Moreover, the device of the invention has a bridge element for bypassing the connection brought about by the switch between the first pair of clamps and the pair of generator clamps. The bridge element is equipped with a voltage-dependent resistor (“varistor”)—used here not as overvoltage protection and therefore a typically—which has an on-state voltage lying above the difference between the first and second generator voltage and below the first generator voltage picked off from the first pair of clamps. If the switch of the control relay connects the pair of generator clamps to the first or the second pair of clamps, practically no voltage will drop along the connection of the first pair of clamps to the pair of generator clamps. Thanks to the lack of a potential difference and the resulting lack of flow through the varistor, the bridge element acts as a blocking element. However, if the switch of the control relay is switched between the first and second pair of clamps, the potential of the first pair of clamps will be imposed on the varistor during the switching process and the bridge element will serve as a flow-through element, suitable for conducting the load current across the connection between the first pair of clamps and the pair of generator clamps, interrupted by the switch being open. To avoid a short circuit, when the switch connects the second pair of clamps to the pair of generator clamps the on-state voltage of the varistor must be chosen so that it lies above the difference between the first and second generator voltage. In advantageous manner, the bridge element can prevent an interruption in the current during the switching process.

A preferred embodiment of the invention calls for the voltage regulation to be within a tolerance range of ±5%. This means that the voltage is regulated up or down as soon as the rated voltage drops or rises by 5%. Likewise, it is preferable for the voltage regulation under a resistive load to occur in the neighborhood of around 50-80% of the rated load current. If the load is resistive-inductive, the switch points are shifted accordingly to higher relative percentages of the rated load current. In particular, the device of the invention is designed conformable to design class G2 of DIN standard 8528, which governs the voltage regulating accuracy for current producing apparatus in accordance with the tolerances in public utility networks.

The invention shall now be explained more closely by means of the description of a sample embodiment, making reference to the enclosed drawings. These show:

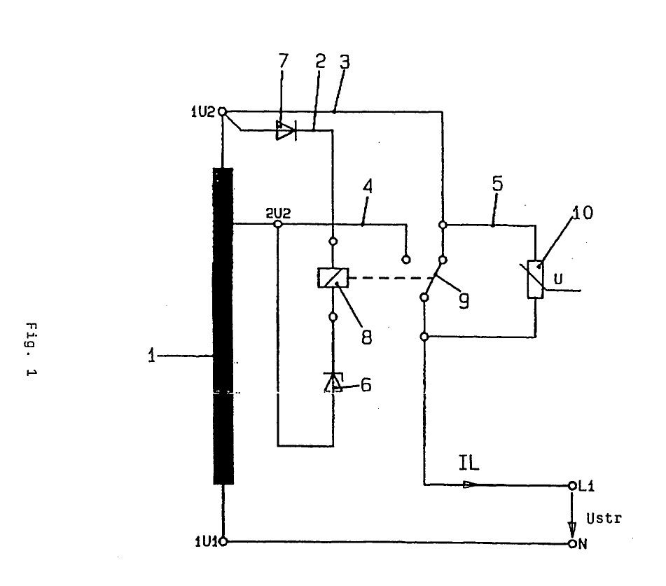

FIG. 1 a circuit diagram of a device according to the invention for voltage regulation of a permanently excited synchronous generator,

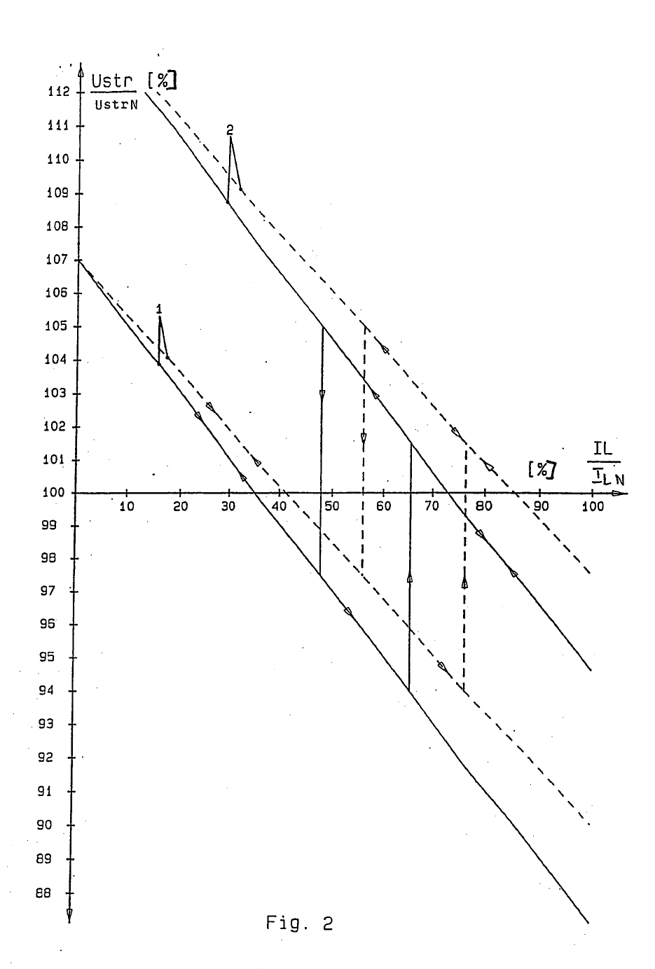

FIG. 2 the phase voltage of a rotary current phase as a function of the load current under resistive load (broken lines) and resistive-inductive load (solid lines), as well as the switching processes triggered by the device of the invention.

FIG. 1 shows, as an example, the circuit diagram of a device per the invention for voltage regulation of a phase of a permanently excited synchronous generator. Only the generator winding 1 and the generator clamps N, L1 of the current producer are depicted. From the generator winding 1, a first pair of clamps 1U1, 1U2 and a second pair of clamps 1U1, 2U2 pick off a first and a second generator voltage. The first pair of clamps 1U1, 1U2 encompasses the full number of turns of the generator winding, while the second pair of clamps 1U1, 2U2 encompasses a lesser number of turns. Since the induced voltage is proportional to the number of turns, the second generator voltage is always smaller than the first generator voltage. Both the first and the second pair of clamps can be connected to the generator clamp L1, N.

A switching relay 8 with a switch 9 is used to connect the generator clamp L1, N to the first or second pair of clamps. The switching relay 8 is situated in a control circuit 2, which is connected to the clamps 2U2 and 1U2 of the first and second pair of clamps, and thus it picks off the difference voltage between first and second generator voltage. Moreover, the control circuit 2 has a Zener diode 6 and a rectifying diode 7. The Zener diode 6 produces a blocking effect, such that only after exceeding the Zener avalanche voltage does the control circuit 2 begin to pass current. The rectifying diode 7 is used to rectify the alternating current, which makes it possible to use a direct current switching relay 8 with advantage.

As soon as the voltage induced between the clamps 1U1 and 2U2 exceeds an upper threshold voltage, which is dictated by the avalanche voltage of the Zener diode 6, the on-state voltage of the rectifying diode 7, and the pulling voltage of the control relay 8, a current flows in the control circuit 2, causing the control relay 8 to pull the switch 9. This causes the voltage imposed on the pair of generator clamps N, L1 to switch from the higher voltage value 1U2 to the lower voltage value 2U2. The load current which brings about this switching event is then conducted across the circuit 4 of the second pair of clamps. The decreasing of the load current between the clamps of the control circuit 1U2, 2U2 causes a further increasing of the control voltage picked off there, which sustains the switching process. Thus, the action of the load current on the voltage is preserved in this branch.

If the load current increases further, the picked-off control voltage decreases, which produces another switching of the control relay 8 as soon as the control voltage reaches a lower threshold voltage. The lower threshold voltage is dictated by the avalanche voltage of the Zener diode 6, the on-state voltage of the rectifying diode 7 and the release voltage of the control relay 8. Due to the switching hysteresis of the switch relay, the lower threshold voltage is always lower than the upper threshold voltage. If the control voltage falls below the avalanche voltage of the Zener diode 6, no more current will flow in the control circuit 2. The increasing internal resistance between the clamps of the control circuit 1U2, 2U2, produced by the load current with the switching from the second pair of clamps to the first pair of clamps, leads to a further decrease in the control voltage, which sustains the switching process.

An interruption in the current flow during the switching is prevented by a varistor 10 arranged in a bridge element 5. The varistor is high-resistive in the voltage-free state and thus does not allow any electrical current flow. If, on the other hand, the voltage increases on its leads, it flips to the low-resistive state at a certain on-state voltage and conducts the electric current through the circuit 3. If the switch 9 connects the first pair of clamps to the pair of generator clamps, practically no more voltage will drop across the leads of the bridge element—the varistor is high-resistive and acts as a blocking element. During the switching of the switch 9 from the first pair of clamps to the second pair of clamps, the potential of the clamp 1U2 is imposed on the varistor, which places it in the low-resistive state, and it conducts the load current. Once the switch 9 has accomplished the connection of the pair of generator clamps to the second pair of clamps, current is conducted across the circuit 4, consequently the varistor again becomes high-resistive and blocks the current flow across the bridge element. The same holds for the switching of the switch 9 from the clamp 2U2 to the clamp 1U2. A higher on-state voltage of the varistor than the difference between the voltage picked off at clamp 2U2 and 1U2 prevents a short circuit from occurring through the circuit 3 when the switch 9 connects the pair of generator clamps N, L1 to the second pair of clamps 1U1, 2U2. In order to keep the internal varistor losses as low as possible, the switch 9 should operate as fast as possible.

FIG. 2 shows the strand voltage U_{Str} (phase voltage) picked off by the generator clamp L1, N, expressed as % of the rated voltage U_{StrN}, as a function of the load current I_{L}, expressed as % of the rated load current I_{LN}, for the case of a pure resistive load (broken lines), when current and voltage are in phase, i.e., cos φ=1, where φ corresponds to the angle between current and voltage, and a resistive-inductive load (solid lines), when cos φ=0.8.

Voltage curve 2 corresponds to the voltage of the first generator voltage, picked off by the first pair of clamps 1U1, 1U2, while voltage curve 1 corresponds to the voltage of the smaller, second generator voltage, picked off by the second pair of clamps 1U1, 2U2.

The switching process is based on a tolerance range of ±7%. At no load (i.e., I_{L}=0), the generator clamp voltage is around 107% of the rated voltage and corresponds to the voltage picked off between 1U1 and 2U2.

Let us consider a resistive load (broken lines). If the generator, starting from the zero load (broken line curve 1; I_{L}=0), is placed under electrical load, and if the load current is continually increased, at around 77% of the rated load current one will reach the switch threshold (upper threshold voltage) of the control relay, and the generator clamp L1 will be connected to the clamp 1U2 of the first pair of clamps. This results in a voltage jump from around 94% to around 101% of the strand voltage. If the load current is further increased, the strand voltage will decrease according to broken-line curve 2.

If the load is then removed from the generator, i.e., the load current is continually decreased, then the voltage picked off at the generator clamp increases per broken-line curve 2, until it reaches the switching threshold (lower threshold voltage) of the switch relay at around 55% of the rated load current, and the generator clamp L1 is connected to the clamp 2U2 of the second pair of clamps. This results in a voltage jump from around 105% to around 98% of the strand voltage. If the load current is further decreased, the strand voltage will increase according to the broken-line curve 1. Finally, at no load (I_{L}=0), it reaches 107% of the rated strand voltage.

The hysteresis of the switching relay is noticeable between the two switching thresholds. The peaks of the hysteresis are located at around 77% and 55% of the rated load current. The area bounded out by the hysteresis depends on the relative distance between the switching thresholds, as well as the gradient of the strand voltage.

The invented device is intended for regulating the phase voltage of each rotary current phase, i.e., a total of three times for three rotary current phases. It works to special advantage with an unbalanced load, since the voltage decreases for a heavily loaded phase and the voltage increases for a weakly loaded phase.

In particular, the invented devices can be joined together in a cascade, the distance between the first and second generator voltage becoming increasingly more narrow within the cascade, so that the voltage regulation becomes finely graduated.

A preferred use of the invented device is the self-activated regulation of the voltage of an electrical current producer, powered by a reciprocating internal combustion engine, as a function of the load current. This can involve, in particular, a synchronous generator powered by a Diesel motor. A permanently excited current producer is preferred according to the invention.

1. Device for automatic regulation of the voltage of an electrical current producer (“generator”) depending on the load current, comprising:
a first pair of clamps (1U1, 1U2), which can be connected to a pair of generator clamps (N, L1) carrying the load current, for picking off a first generator voltage from the generator winding, a second pair of clamps (1U1, 2U2), which can be connected to the pair of generator clamps (N, L1), for picking off a second generator voltage from the generator winding that is smaller than the first generator voltage,
a third pair of clamps (1U2, 2U2) for supplying a control voltage to a control circuit (2), which control circuit (2) is outfitted with a control relay (8) with a switch (9) for switching the connection between the pair of generator clamps (N, L1) and the first or second pair of clamps, wherein the pair of generator clamps (N, L1) connected by the switch (9) to the first pair of clamps (1U1, 1U2) is connected to the second pair of clamps (1U1, 2U2) if the control voltage is greater than or equal to an upper threshold voltage of the switch relay, while the pair of generator clamps (N, L1) connected by the switch (9) to the second pair of clamps (1U1, 2U2) is connected to the first pair of clamps (1U1, 1U2) if the control voltage is less than or equal to a lower threshold voltage of the switch relay,
a bridge element (5), which bypasses the connection of the pair of generator clamps (N, L1) to the first pair of clamps (1U1, 1U2) produced by the switch (9), with a voltage-dependent resistor (“varistor”) (10), whose on-state voltage lies above the difference between first and second generator voltage and below the first generator voltage picked off from the first pair of clamps.

2. Device per claim 1, characterized in that the control voltage of the control circuit corresponds to the voltage difference between first generator voltage and second generator voltage.

3. Device per claim 1, characterized in that the control circuit (2) becomes conducting upon reaching an on-state voltage.

4. Device per claim 3, characterized in that the control circuit (2) has a Zener diode (6), whose avalanche voltage corresponds to the on-state voltage of the control circuit (2).

5. Device per claim 1, characterized in that the control circuit (2) has a current rectifying element, in particular, a rectifying diode (7).

6. Device per claim 1, characterized in that the first generator voltage picked off with the first pair of clamps (1U1, 1U2) corresponds to the main generator voltage.

7. Device per claim 1, characterized in that the voltage regulation occurs within a tolerance range of ±5%.

8. Device per claim 1, characterized in that the voltage regulation under a resistive load is done at approximately 50-80% of the rated load current.

9. Device per claim 1, characterized in that it conforms to design class G2 of the DIN standard 8528.

10. Device per claim 1, in which the electrical current producer is permanently excited.

11. Arrangement characterized by devices according to claim 1 for each rotary current phase.

12. Arrangement characterized by a cascade arrangement of devices according to claim 1, wherein the voltage difference between the first generator voltage and the second generator voltage continually decreases within the cascade.

13. Use of the device according to claim 1 for the automatic, load current dependent regulating of the voltage of an electrical current producer, especially a synchronous generator, powered by a reciprocating internal combustion engine, especially a Diesel motor.
